(19) United States
(12) Patent Application Publication
(10) Pub. No.: US 2025/0004271 A1
(43) Pub. Date: Jan. 2, 2025

(54) OPTICAL IMAGING MODULE AND AR DEVICE

(71) Applicant: Goertek Optical Technology Co., Ltd., Weifang, Shandong (CN)

(72) Inventor: Henglin Guo, Shandong (CN)

(73) Assignee: Goertek Optical Technology Co., Ltd., Weifang, Shandong (CN)

(21) Appl. No.: 18/705,773

(22) PCT Filed: Nov. 29, 2021
(86) PCT No.: PCT/CN2021/133850

§ 371 Date: Apr. 29, 2024

(30) Foreign Application Priority Data
Oct. 29, 2021 (CN) 202111279972.5

(51) Int. Cl. G02B 27/01; G02B 9/34; G02B 13/00

(52) U.S. Cl. CPC G02B 27/0101; G02B 9/34; G02B 13/005

(57) ABSTRACT

The present disclosure provides an optical imaging module, comprising: a stop, a lens assembly, and a light source; the lens assembly includes a first lens, a second lens, a third lens, and a fourth lens arranged in order, with the light source located on the object side of the fourth lens, and the stop located on the image side of the first lens; the first lens has a positive focal power, the second lens has a positive focal power, the third lens has a negative focal power, and the fourth lens has a positive focal power; and the optical imaging module satisfies the inequality: 0.5 mm<TL/D<3 mm; where TL is the distance between the light source and the stop, and D is the maximum lens diameter of the first lens, the second lens, the third lens, and the fourth lens.

### CROSS-REFERENCE TO RELATED APPLICATIONS

The present disclosure is a National Stage of International Application No. PCT/CN2021/133850 filed on Nov. 29, 2021, which claims priority to Chinese Patent Application No. 202111279972.5 filed with the CNIPA on Oct. 29, 2021 and entitled “Optical Imaging Module and AR Device,” both of which are hereby incorporated by reference in their entireties.

### TECHNICAL FIELD

The present disclosure relates to the field of optical technologies, and specifically to an optical imaging module and an AR device.

### BACKGROUND

With the development of computer technology, various wearable device products have emerged as the times require, among them, AR (Augmented Reality), VR (Virtual Reality), MR (Mediated Reality), XR, and like devices have increasingly attracted people's attention. Among them, the AR technology is a technology that cleverly integrates virtual information with the real world, widely using multimedia, three-dimensional modeling, real-time tracking and registration, intelligent interaction, sensing, and other technical means to simulate and apply computer-generated text, images, three-dimensional models, music, videos, and other virtual information to the real world, with the two types of information complementing each other, thereby achieving an “augmentation” of the real world.

Currently, AR devices are generally of relatively heavy weight, while a primary demand on the performance of an AR device is the comfort in wear. Therefore, to improve user experience, the lightweight of AR devices has become a technical problem that demands urgent solution. An optical imaging module, as an important functional component of AR devices, the optical performance and weight thereof greatly influence the user experience of AR devices.

### SUMMARY

One purpose of the present disclosure is to provide a new technical solution for an optical imaging module and an AR device to solve at least one of the technical problems proposed in the Background section.

According to the first aspect of the present disclosure, an optical imaging module is provided, which includes:

A stop, a lens assembly, and a light source;

The lens assembly includes a first lens, a second lens, a third lens, and a fourth lens arranged in order, with the light source located on the object side of the fourth lens, and the stop located on the image side of the first lens;

The first lens has a positive focal power, the second lens has a positive focal power, the third lens has a negative focal power, and the fourth lens has a positive focal power;

The optical imaging module satisfies the following inequality:

$$0.5 mm < TL / D < 3 mm ;$$

Where TL is the distance between the light source and the stop, and D is the maximum lens diameter of the first lens, the second lens, the third lens, and the fourth lens.

Optionally, the lens assembly satisfies the following inequality:

$$4 mm < f < 11.7 mm ;$$

Where f is the total effective focal length of the lens assembly.

Optionally, the first lens, the second lens, the third lens, and the fourth lens respectively satisfy the following inequalities:

$$10 mm < f 1 < 16.3 mm ;$$

$$6 mm < f 2 < 12.1 mm ;$$

$$- 6 mm < f 3 < - 1.4 mm ; and$$

$$2 mm < f 4 < 8 mm ;$$

Where f1 is the effective focal length of the first lens, f2 is the effective focal length of the second lens, f3 is the effective focal length of the third lens, and f4 is the effective focal length of the fourth lens.

Optionally, the stop has an aperture diameter of 4 mm, and a diameter of the fourth lens is larger than those of the first, second, and third lenses.

Optionally, the first lens, the second lens, the third lens, and the fourth lens are all glass spherical lenses.

Optionally, the refractive index of the fourth lens is greater than 1.75, and both the object side and image side of the fourth lens are convex surfaces.

Optionally, the light source is a self-luminous light source.

Optionally, the light source is a micro-LED monochrome light source.

According to the second aspect of the present disclosure, an AR device is provided, which includes the optical imaging module described in the first aspect.

Optionally, the AR device also includes an optical waveguide structure, where light emitted from the light source passes through the lens assembly and is then transmitted through the optical waveguide structure before being emitted into the human eye.

According to one embodiment of the present disclosure, the AR optical imaging module provided by the present disclosure has a lens assembly composed of a first lens, a second lens, a third lens, and a fourth lens. By adopting a positive-negative distribution method for the distribution of the focal power of each lens and limiting the ratio of the distance between the light source and the stop to the maximum lens diameter, the optical efficiency of the AR optical imaging module is improved, and the system weight is reduced.

The other features and advantages of the present disclosure will be clarified through the following detailed description of the exemplary embodiments of the present disclosure with reference to the accompanying drawings.

### BRIEF DESCRIPTION OF THE DRAWINGS

To clearly illustrate the technical solutions of the embodiments of the present disclosure or the prior art, a brief introduction to the drawings required in the description of the embodiments or the prior art will be provided below. It is evident that the drawings described below are only part of the drawings of the present disclosure, and for a person of ordinary skill in the art, other drawings can be obtained based on the provided drawings without creative effort.

FIG. 1 is a schematic illustration of a structure of an optical imaging module of the present disclosure.

FIG. 2 is the MTF of each field of view of the optical imaging module of the present disclosure.

FIG. 3 is the distortion of each field of view of the optical imaging module of the present disclosure.

FIG. 4 is the MTF value of each field of view of the optical imaging module at 60° C.

Reference Signs: 1, first lens: 2, second lens: 3, third lens: 4, fourth lens; 5, light source: 6, stop.

### DETAILED DESCRIPTION

The technical solution of the present disclosure will be described below in combination with the accompanying drawings of the embodiment of the present disclosure. It is evident that the described embodiment is only a part of the embodiments of the present disclosure, not all of them. Based on the embodiment in the present disclosure, all other embodiments obtained by a person of ordinary skill in the field without creative effort shall fall into the scope of protection of the present disclosure.

It should be noted that similar reference signs and alphabetical letters represent similar items in the following drawings, as such, once an item is defined in one drawing, it does not need to be further discussed in subsequent drawings.

AR devices usually contain various components, such as heat dissipation components, optical structures (optomechanics), driving boards, etc. The optical imaging module of the present disclosure is a part of the optical structure, providing an imaging light path for the optical structure. In the prior art, while ensuring the basic functions, the comfort of wearing AR devices is also very important, especially for AR glasses, where lightweight is a major factor in improving the user experience. Therefore, the present disclosure provides an optical imaging module applicable to AR devices, which can realize light-weighting of the entire AR device by reducing its own weight while ensuring optical efficiency.

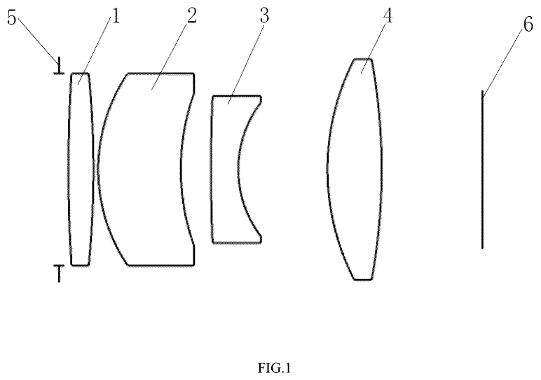

As shown in FIG. 1, the present disclosure provides an optical imaging module, which includes a stop 6, a lens assembly, and a light source 5; the lens assembly includes a first lens 1, a second lens 2, a third lens 3, and a fourth lens 4 arranged in order, with the light source 5 located on the object side of the fourth lens 4, and the stop 6 located on the image side of the first lens 1; the first lens 1 has a positive focal power, the second lens 2 has a positive focal power, the third lens 3 has a negative focal power, and the fourth lens 4 has a positive focal power; the optical imaging module satisfies the inequality: 0.5 mm<TL/D<3 mm; where TL is the distance between the light source 5 and the stop 6, and D is the maximum lens diameter of the first lens 1, the second lens 2, the third lens 3, and the fourth lens 4.

Specifically, in this embodiment, the lens assembly is composed of four lenses, all of which share the same optical axis. The light beam emitted from the light source 5 can sequentially pass through the fourth lens 4, the third lens 3, the second lens 2, and the first lens 1 of the lens assembly, and finally exit from the first lens 1, forming an image on the image side of the lens assembly.

In one embodiment, the third lens 3 has a negative focal power, and at least one of its object side and image side can be concave surface(s), that is, the third lens 3 may have a convex object side and a concave image side, or may have a concave object side and a convex image side, or both the object side and the image side may be concave surfaces. The fourth lens 4 has a positive focal power, and at least one of its object side and image side may be convex surface(s), that is, the fourth lens 4 may have a convex object side and a concave image surface, or may have a concave object side and a convex image side, or both the object side and the image side may be convex. Additionally, the first lens 1 has a positive focal power, which means both the object side and the image side thereof can be convex. The second lens 2 also has a positive focal power, with a concave object side and a convex image side. Furthermore, the stop 6 serves to constrain the light beam and can be an edge or a frame of the lens, or can be a specially set perforated screen, with no specific limitations in the present disclosure.

Compared to prior art, the present disclosure reduces the number of lenses, effectively reducing total system weight. The reduction in the number of lenses also means fewer variable parameters, which can help improve the optical efficiency of the system. Additionally, by setting the ratio of the distance between the light source 5 and the stop 6 to the maximum lens diameter within a certain range, the overall length (equivalent to TL) or width (equivalent to D) of the optical imaging module can be kept within an appropriate range, making the overall size of the optical module more reasonable. The specific dimensions of the length and width of the optical module can be adjusted according to the actual application environment, with no specific limitations in the present disclosure.

Optionally, the effective focal length f of the lens assembly satisfies the inequality:

$$4 mm < f < 11.7 mm .$$

Specifically, the present disclosure defines the effective focal length of the lens assembly to be within the range of 4 mm<f<11.7 mm. The effective focal length f of the lens assembly is related to the individual effective focal lengths of the lenses and the distances between the lenses, and the individual effective focal lengths of the lenses in turn are influenced by the curvature radii and thicknesses of each lens. By further defining the total focal length of the system in this embodiment to be within the range of 4 mm<f<11.7 mm, it is possible to achieve excellent optical performance with just four lenses.

Optionally, the first lens 1, the second lens 2, the third lens 3, and the fourth lens 4 respectively satisfy the following inequalities:

$$10 mm < f 1 < 16.3 mm ;$$

$$6 mm < f 2 < 12.1 mm ;$$

$$- 6 mm < f 3 < - 1.4 mm ;$$

$$2 mm < f 4 < 8 mm ;$$

Where f1 is the effective focal length of the first lens 1, f2 is the effective focal length of the second lens 2, f3 is the effective focal length of the third lens 3, and f4 is the effective focal length of the fourth lens 4.

Specifically, the effective focal length of the lens assembly is influenced by the effective focal lengths of each lens. By setting the first lens 1, the second lens 2, the third lens 3, and the fourth lens 4 to satisfy the above focal length ranges, it is possible to improve the optical efficiency of the optical lens module while ensuring that the effective focal length of the lens assembly remains within the range of 4 mm<f<11.7 mm.

Optionally, the stop 6 has an aperture diameter of 4 mm, and the diameter of the fourth lens 4 is larger than those of the first lens 1, the second lens 2, and the third lens 3.

Specifically, in this embodiment, the light source 5 can emit light through the lens assembly, which light exit from one side of the stop 6. The optical imaging module of this embodiment is generally applied in AR devices, and the final imaging light beam needs to reach the human eye. By setting the aperture diameter of the stop 6 to be 4 mm, the imaging light beam is more clearly and completely directed into the human eye. Additionally, in this embodiment, the diameter of the fourth lens 4 is larger than those of the first lens 1, the second lens 2, and the third lens 3, facilitating the entry of light emitted by the light source 5 into the lens assembly and improving the optical efficiency of the optical lens module.

Optionally, the first lens 1, the second lens 2, the third lens 3, and the fourth lens 4 are all glass spherical lenses.

Specifically, in this embodiment, the first lens 1, the second lens 2, the third lens 3, and the fourth lens 4 are all glass spherical lenses. Glass spherical lenses are manufactured using glass material, which has a relatively small temperature drift, allowing the optical imaging module to maintain good image clarity even in high-temperature environments.

Optionally, the fourth lens 4 has a refractive index greater than 1.75, and both the object side and image side of the fourth lens 4 are convex surfaces.

Specifically, in the optical imaging module with a lens assembly, due to the different converging capabilities of the central and edge regions of the lens for electromagnetic waves, spherical aberration may occur, which limits the resolving power of the lens. In this embodiment, the AR devices typically use a monochrome light source 5. By increasing the refractive index of the fourth lens 4 and making both the object side and image side convex, the aberrations of the monochrome light source 5 can be corrected, thus improving the imaging clarity of the entire device and reducing the correction cost.

Optionally, the light source 5 is a self-luminous light source. The light source 5 is a micro-LED monochrome light source.

Specifically, the self-luminous light source 5 has a simple structure and can be placed as close as possible to the lens (fourth lens 4), thereby further reducing the volume of the entire optical imaging module. Micro-LED is a display technology that uses self-luminous micrometer-sized LEDs as light-emitting pixel units, which are assembled onto a driving panel to form a high-density LED array. Due to the small chip size, high integration, and self-luminous characteristics of micro-LEDs, they have greater advantages in terms of brightness, resolution, contrast, power consumption, lifespan, response speed, and thermal stability compared to LCDs and OLEDs. This embodiment uses a micro-LED monochrome light source 5 as the light source for the optical imaging module, which not only simplifies the module's structure but also extends its service life, and the correction cost of the monochrome light source 5 is low, making it suitable for AR devices.

To make the beneficial effects of the present disclosure more apparent, the following specific embodiments are provided for reference.

In this embodiment, the first lens 1 has a convex object side and a convex image side, with an effective focal length of 13.12 mm; the second lens 2 has a concave object side and a convex image side, with an effective focal length of 9.223 mm; the third lens 3 has a concave object side, with an effective focal length of −3.445 mm; the fourth lens 4 has a convex object side and a convex image side, with an effective focal length of 4.037 mm. The specific parameters of each lens are as follows in Table 1:

TABLE 1
Parameters of the Lens Assembly

| | | | Refractive | Abbe | |
|---|---|---|---|---|---|
| Surface | Curvature | Thickness | Index | Number | |
| No. | Radius(mm) | (mm) | (Nd) | (Vd) | Description |
| S1 | 30.6 | 0.526 | 1.91 | 35.3 | First Lens |
| S2 | −19.798 | 0.1 | | | |
| S3 | 3.556 | 1.733 | 1.91 | 35.3 | Second Lens |
| S4 | 4.690 | 0.633 | | | |
| S5 | 35.475 | 0.574 | 1.71 | 35.9 | Third Lens |
| S6 | 2.297 | 1.871 | | | |
| S7 | 4.992 | 1.137 | 1.90 | 31.3 | Fourth Lens |
| S8 | −12.645 | 2.110 | | | |

Where S1, S3, S5, S7 represent the image sides of the first lens 1, the second lens 2, the third lens 3, and the fourth lens 4, respectively, which are the sides distal to the light source 5: while S2, S4, S6, S8 represent the object sides of the first lens 1, second lens 2, third lens 3, and fourth lens 4, respectively, which are the sides proximate to the light source 5. Thickness refers to the distance between two adjacent surfaces, for example, the distance from S1 to S2 located at the optical axis position of the lens is 0.526 mm, the distance from S2 to S3 is 0.1 mm, . . . , the distance from S7 to S8 is 1.137 mm, and the distance from S8 to the light source 5 is 2.110 mm.

Additionally, the light source 5 in this embodiment uses a micro-LED green rectangular light source with an aspect ratio of 16:9, with specific dimensions of 2.877*1.618 mm, and the stop 6 has an aperture diameter of 4 mm.

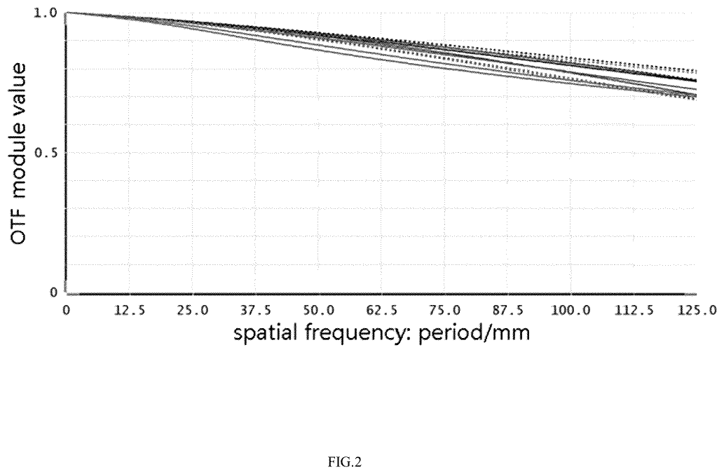

Based on the above parameters, it can be derived that the total effective focal length of the lens assembly is 6.73, and the total system length DL is 8.5 mm. After measuring, the resulting parameters of the optical imaging module for each field of view are shown in FIGS. 2 to 4.

As shown in FIG. 2, this is the MTF value (Modulation Transfer Function, a scientific method for analyzing the resolution of lenses) of the optical imaging module. It can be seen from the figure that the MTF values of each field of view are all above 0.65 (typically need to be >0.5), indicating that the image clarity after imaging through this system in each field of view will be very good.

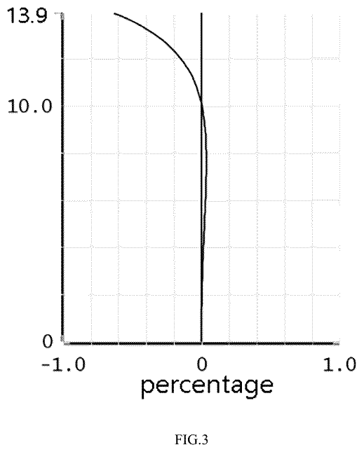

As shown in FIG. 3, this is the distortion value of each field of view of the optical imaging module. It can be seen from the figure that the distortion values of each field of view are all less than 0.6% (typically need to be less than <1%), indicating that the TV distortion after imaging through this system in each field of view will also be small, fully meeting the requirements of the human eye for distortion.

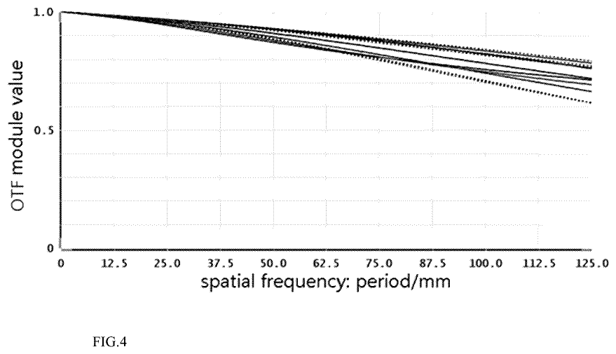

As shown in FIG. 4, this is the MTF value of the optical imaging module at 60° C. Since the AR optical system is used in conjunction with the human eye, the operating temperature is not very high. It can be seen from the figure that the MTF values of each field of view at 60° C. are all above 0.6, indicating that the temperature drift of the glass lenses in this system is very small at high temperatures, and it can still maintain good image clarity.

From the above example, it can be seen that the optical imaging module provided by the present disclosure can achieve a TY distortion of <1%: a full field of view MTF of >0.5@125 lp/mm: and a telecentricity of <1.5°, with the total system length being only 8.5 mm. It can be seen that the optical imaging module provided by the present disclosure can further simplify the module structure (reduction in the number of lenses) and reduce the system weight while ensuring its optical efficiency.

According to the second aspect of the present disclosure, an AR device is provided, which includes the optical imaging module described in the first aspect.

Specifically, in this embodiment, the imaging light path of the AR device is provided by the optical imaging module of the present disclosure. While ensuring good optical efficiency of the AR device, the weight and volume of the entire AR device are reduced, improving the user experience.

Optionally, it also includes an optical waveguide structure, where the light emitted from the light source passes through the lens assembly and is then transmitted through the optical waveguide structure before being emitted into the human eye.

Specifically, in this embodiment, the optical imaging module is combined with the optical waveguide structure, allowing the imaging light beam emitted from the module to enter the human eye through the coupling of the optical waveguide structure. The optical waveguide structure can provide a deflected light path and a pupil expansion effect, and the pupil expansion effect can expand the imaging light beam, making the AR device made with the optical imaging module provided by the present disclosure suitable for the interpupillary distances of people of different genders and ages.

The above embodiments focus on the differences between each embodiment, and as long as the different optimization features between the embodiments are not contradictory, they can be combined to form a better embodiment. Considering the brevity of the text, it will not be further elaborated here.

Although specific embodiments of the present disclosure have been described in detail through examples, those skilled in the art should understand that the above examples are for illustrative purposes only and are not intended to limit the scope of the present disclosure. Those skilled in the art should understand that the above embodiments can be modified without departing from the scope and spirit of the present disclosure. The scope of the present disclosure is defined by the appended claims.

1. An optical imaging module, comprising:
a stop,
a lens assembly, and
a light source;
wherein
the lens assembly comprises a first lens, a second lens, a third lens, and a fourth lens arranged in order, with the light source located at an object side of the fourth lens, and the stop located at an image side of the first lens;
the first lens has a positive focal power, the second lens has a positive focal power, the third lens has a negative focal power, and the fourth lens has a positive focal power; and
the optical imaging module satisfies the following inequality:
$$0.5 mm < TL / D < 3 mm ;$$
where TL is a distance between the light source and the stop, and D is the maximum lens diameter of the first lens, the second lens, the third lens, and the fourth lens.

2. The optical imaging module according to claim 1, wherein the lens assembly satisfies the following inequality:
$$4 mm < f < 11.7 mm ;$$
where f is a total effective focal length of the lens assembly.

3. The optical imaging module according to claim 2, wherein the first lens, the second lens, the third lens, and the fourth lens respectively satisfy the following inequalities:
$$10 mm < f 1 < 16.3 mm ;$$
$$6 mm < f 2 < 12.1 mm ;$$
$$- 6 mm < f 3 < - 1.4 mm ; and$$
$$2 mm < f 4 < 8 mm ;$$
where f1 is an effective focal length of the first lens, f2 is an effective focal length of the second lens, f3 is an effective focal length of the third lens, and f4 is an effective focal length of the fourth lens.

4. The optical imaging module according to claim 1, wherein the stop has an aperture diameter of 4 mm, and a diameter of the fourth lens is larger than that of the first lens, the second lens, and the third lens.

5. The optical imaging module according to claim 1, wherein the first lens, the second lens, the third lens, and the fourth lens include glass spherical lenses.

6. The optical imaging module according to claim 1, wherein a refractive index of the fourth lens is greater than 1.75, and both an object side and an image side of the fourth lens include convex surfaces.

7. The optical imaging module according to claim 1, wherein the light source includes a self-luminous light source.

8. The optical imaging module according to claim 7, wherein the light source includes a micro-LED monochrome light source.

9. An AR device, comprising an optical imaging module according to claim 1.

10. The AR device according to claim 9, further comprising an optical waveguide structure, where light emitted from the light source passes through the lens assembly and is then transmitted through the optical waveguide structure before being emitted into a human eye.
